(19) United States
(12) Patent Application Publication
(10) Pub. No.: US 2013/0325737 A1
(43) Pub. Date: Dec. 5, 2013

(54) System And Method To Determine Shipping Information

(71) Applicants: Geoffrey Smalling, San Anselmo, CA (US); William Clifford, San Francisco, CA (US)

(72) Inventors: Geoffrey Smalling, San Anselmo, CA (US); William Clifford, San Francisco, CA (US)

(73) Assignee: Wine.com, Inc., San Francisco, CA (US)

(21) Appl. No.: 13/484,258

(22) Filed: May 30, 2012

(51) Int. Cl. G06Q 10/08

(52) U.S. Cl. 705/330

(57) ABSTRACT

A system to determine shipping information is described. The system including memory, one or more processors, and one or more modules stored in memory and configured for execution by the one or more processors. The modules including a shipping options module configured to determine at least one shipping option based on an input received from a user device. A date determination module coupled with the shipping options module. The date determination module configured to determine at least one delivery date of a shipment responsive to the input. And, a format module configured to transform the at least one shipping option and the at least one delivery date into a format for the user device.

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever

### FIELD

Embodiments of the invention relate to a system for determining shipping information. In particular, embodiments of the invention relate to a system to determine available shipping options and to determine a shipment delivery date.

### BACKGROUND

An online shopping system provides a user the benefit of shopping for merchandise from any location. Once the user purchases merchandise from such an online shopping system, the system provides options for shipping the merchandise to a user such as ground shipping, two day shipping, or overnight shipping. In some cases, an online shipping system might provide a delivery window or range including many dates that merchandise might be delivered. But, such a system does not provide a user the ability to select a date for delivery or take into account other factors that may affect the type of merchandise that is shipped, such as extreme weather. As such, current shopping systems provide no certainty to a user at the point of sale that merchandise will be delivered on a specific date. In addition, current shopping systems provide no certainty at the point of sale that shipping methods will not expose the merchandise to factors that negatively affect the merchandise during shipping.

### SUMMARY

A system to determine shipping information is described. The system including memory, one or more processors, and one or more modules stored in memory and configured for execution by the one or more processors. The modules including a shipping options module configured to determine at least one shipping option based on an input received from a user device. A date determination module coupled with the shipping options module. The date determination module configured to determine at least one delivery date of a shipment responsive to the input. And, a format module configured to transform the at least one shipping option and the at least one delivery date into a format for the user device.

Other features and advantages of embodiments will be apparent from the accompanying drawings and from the detailed description that follows.

### BRIEF DESCRIPTION OF THE DRAWINGS

Embodiments are illustrated by way of example and not limitation in the figures of the accompanying drawings, in which like references indicate similar elements and in which:

FIG. 1 illustrates a block diagram of an embodiment of a system on a user device;

FIG. 2 illustrates a block diagram of a distributed system according to an embodiment;

FIG. 3 illustrates a flow diagram for determining shipping information according to an embodiment;

FIG. 4 illustrates a flow diagram for determining shipping information and delivery dates according to an embodiment;

FIG. 5 illustrates a document generated to display determined shipping options and determined delivery dates according to an embodiment;

FIG. 6 illustrates a list of determined shipping options and delivery options according to an embodiment;

FIG. 7 illustrates a list of determined shipping information based on determined weather conditions according to an embodiment;

FIG. 8 illustrates a graphic user interface for selecting a delivery date according to an embodiment;

FIG. 9 illustrates a graphic user interface for a shopping cart that includes determined shipping information according to an embodiment;

FIG. 10 illustrates a graphic user interface for a shopping cart that includes determined shipping information with format information;

FIG. 11 illustrates a graphic user interface for a shopping cart that includes determined shipping information and content information based on determined weather conditions;

FIG. 12 illustrates a graphic user interface for a shopping cart that includes determined shipping information and a graphic user interface based on determined weather conditions;

FIG. 13 illustrates a block diagram of a system according to an embodiment; and

FIG. 14 illustrates a block diagram of a client according to an embodiment.

### DETAILED DESCRIPTION

Embodiments of a system to determine shipping information are described. Specifically, an embodiment of a system is configured to determine shipping information based on factors including, but not limited to, a type of merchandise, a location of merchandise, a user preference, a business rule or other factors. Based on merchandise selected and/or user preferences, a system, according to an embodiment determines shipping information available for one or more merchandise. According to an embodiment, a system determines a delivery date for merchandise based on shipping options available. An embodiment also includes the ability to modify delivery date of merchandise based on current and/or predicted weather conditions.

An embodiment of a system includes an online shopping system that sells merchandise that is regulated. For example, such a system may sell alcohol products including, but not limited to, wine, spirits, and beer. Because of regulations, certain products, such as alcohol products, require an adult signature for the products to be delivered. For an embodiment, an online shopping system may be used to sell merchandise that is susceptible to temperature variations. Examples of merchandise that is susceptible to temperature variations include, but are not limited to, wine, cheese, chocolate, fruit, and other perishable items.

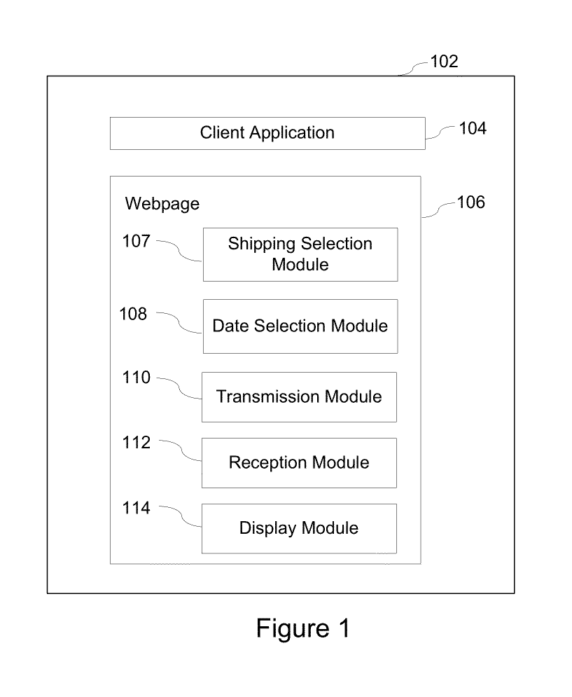

FIG. 1 illustrates a block diagram of an embodiment of a system to determine shipping options on a user device. According to an embodiment, a user device 102 may be any device for viewing a document that includes information including, but not limited to, a mobile phone, a computer, a tablet computer, a personal digital assistant (PDA) or other mobile device. A document includes, but is not limited to, a webpage, a remotely located document, a dynamically generated document, or other document including information. A user device 102, according to an embodiment, includes one or more client applications 104 that may be used to communicate through a network. For some embodiments, a client application 104 may be an application for viewing, searching for, or using resources over a communication network. According to an embodiment, a client application 104 includes a web browser, an application, a script and/or an executable file. Such a client application 104, for an embodiment, may be used for retrieving information from a remote source to provide information to a user device 102 and for retrieving and viewing a document, such as one or more webpages 106.

According to an embodiment, a client application 104 retrieves a webpage 106 using address information including, but not limited to, a domain name, an internet protocol address (“IP address”), a media access control (“MAC”) address, or a uniform resource locator (“URL”). For example, a client application 104 retrieves a webpage 106 from an online shopping system. As illustrated in FIG. 1, the retrieved or accessed webpage 106 may include a shipping selection module 107. According to an embodiment, a shipping selection module 107 may be included in a webpage 106 after a user selects merchandise for purchase. Merchandise may be one or more items. For example, a shipping selection module 107 may be included in a webpage configured as a shopping cart for an online shopping system. A shipping selection module 107, for an embodiment, is configured to request one or more shipping options for merchandise.

For some embodiments, shipping selection module 107 is configured to receive input from a user device 102 indicating a selection of one or more shipping options. Examples of shipping options include carrier service, shipping speed, packaging, conditions on shipping, or other aspects related to the shipping of merchandise. For an embodiment, one or more carriers may be included in a list of shipping options based on the ability to ship to a chosen destination, types of services offered, cost of services or other aspects of a carrier. Shipping speed options may include a type of shipping service such as ground, 2 day, 3 day, overnight, overnight by 3:00 p.m., overnight by 10:30 a.m., or other shipping service level. Examples of conditions on shipping that may be included in a list of shipping options include, but are not limited, shipping based on weather forecasts, shipping with ice packs, shipping with insulation, holding shipment based on current weather conditions or forecasted weather conditions, and other aspects of shipping.

For an embodiment, a shipping section module 107 may be configured to offer a set of shipping options upon a determination that a certain type of merchandise is to be shipped. For example, the merchandise may include perishable items or items sensitive to temperature so shipping options that limit shipping time may be made available for selection. For such items, shipping options may include, but are not limited to, including ice packs, including insulation, offering shipping methods that limit shipping time to less than a week, or including other packing materials to minimize effects from temperature during shipping. For another embodiment, a shipping selection module 107 is configured to request shipping options from a system or server in response to receiving an input. The input may be a user input for example selecting an icon on a screen that opens a shopping cart webpage, a user selecting a button with a user interface to request shipping options, responsive to an item of merchandise being selected for purchase, responsive to other user interactions with a webpage, or other input corresponding to selecting merchandise for shipping or purchase.

According to an embodiment, a shipping selection module 107 includes a client-side script embedded in a webpage 106. The script may be written or coded using Perl, PHP, ASP.NET, Java, VBScript, or any other scripting language. For another embodiment, webpage 106 may include a reference to an external program or script. For a specific embodiment, a shipping selection module 107 is a function in a markup language used to create a webpage 106, such as a function in HyperText Markup Language (“HTML”), in Extensible HyperText Markup Language (“XHTML”) or other language.

The embodiment in FIG. 1 also includes a date selection module 108. According to an embodiment, a date selection module 108 is configured to request one or more dates available for delivery of merchandise selected for shipping or purchase. A date selection module 108, according to an embodiment, is configured to requests one or more delivery dates responsive to an input indicating a preferred shipping option. The input may be a user input, for example, a user selecting an icon on a screen to select one or more shipping options, responsive to an item of merchandise being selected for purchase, or other user interactions with a webpage. According to an embodiment, a date selection module 108 is implemented using techniques similar to those discussed above. For a specific embodiment, a date detection module 108 is a function in a markup language used to create a webpage 106, such as a function in HTML, XHTML, or other language.

According to an embodiment, a date selection module 108 is configured to receive an input to select one or more delivery dates received by a user device 102 in response to a request for delivery dates. As described above, an input may be a user input, for example, a user selecting an icon on a screen to select a delivery date, responsive to a user inputting text in a text box, or other user interactions with a webpage. According to an embodiment, a date selection module 108 is implemented using techniques similar to those described herein for other modules.

As illustrated in FIG. 1, an embodiment may also include a transmission module 110. A transmission module 110 is configured to transmit one or more requests and one or more selections such as a shipping options request from a shipping selection module 107, one or more selected shipping options corresponding to an input received by a shipping selection module 107, a date request from a date selection module 108, and one or more selected delivery dates corresponding to an input received by a date selection module 108. A transmission module 110, according to embodiments, may be a script, a program, or a function associated with a webpage 106 using techniques similar to those discussed with regard to embodiments of a shipping selection module 107. According to an embodiment, a transmission module 110 transmits a request and/or a selection through a communication network back to a system or server, such as an online shopping system. According to an embodiment, a transmission module 110 transforms any request into a format for a system.

A reception module 112, according to an embodiment, is configured to receive content information responsive to a request sent by a transmission module 110. According to an embodiment, a reception module 112 may be a script, a program, or a function associated with a webpage 106 using techniques similar to those discussed with regard to embodiments of a shipping selection module 107. Such content information may include, but is not limited to, information that relates to shipping options, delivery dates, weather conditions, product information, and other information related to products or services offered by a system. For an embodiment, a reception module 112 is configured to receive shipping options based on a type of merchandise selected.

The embodiment illustrated in FIG. 1 also includes a display module 114. According to an embodiment, a display module 114 may be a script, a program, or a function associated with a webpage 106 using techniques similar to those discussed with regard to embodiments of a shipping selection module 107. According to some embodiments, display module may also include markup language, cascading style sheets (“CSS”), or templates used by a client application 104, such as a browser to transform or to render the content information in a format for viewing on a user device 102.

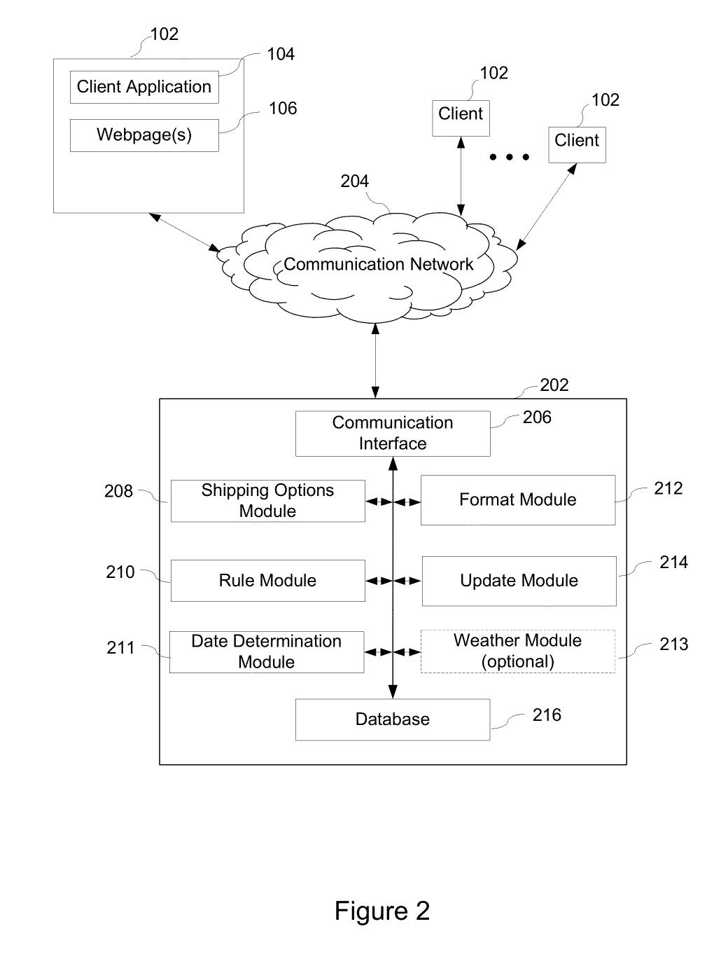

FIG. 2 illustrates a distributed system including a user device 102 coupled with a system 202, system 202 may include, but is not limited to, an online shopping system, a retail system, a shipping system, or other system for determining shipping options for merchandise. According to an embodiment, a user device 102 is coupled with a system 202 through a communication network 204. A communication network 204 includes, but is not limited to, a wide area network (“WAN”), such as the Internet, a local area network (“LAN”), wireless network, or other type of network. According to embodiments, one or more user devices 102 may be communication with system 202 through a communication network 204.

A system 202, according to an embodiment, includes a communication interface 206 configured to communicate with one or more user devices 102 or other clients through a communication network 204 using communication protocols. For some embodiments, a communication interface 206 manages one or more communication sessions between a system 202 and one or more user devices 102. A communication interface 206 may also convert or package data or content information into the appropriate communication protocol depending on the protocol used by a user device 102. According to some embodiments, a communication interface 206 may be configured to use one or more communication protocols for one or more communication layers, such communication protocols include, but are not limited to, hypertext transfer protocol (“HTTP”), transmission control protocol (“TCP”), Internet Protocol (“IP”), user datagram protocol (“UDP”), file transfer protocol (“FTP”), or any other protocol.

A system 202, according to an embodiment, includes a shipping options module 208 that is coupled with a communication interface 206. The shipping options module 208, according to some embodiments, is configured to receive a request for shipping information that includes a request for shipping options from a user device 102. For some embodiments, a request for shipping options may include an indication of the merchandise for shipping, such as a merchandise reference. In another embodiment, the request for shipping options may be a request to view the shopping cart. For some embodiments, a request may include information that corresponds to a destination address including, but not limited to, one of or any combination of a state, a city, a county, a zip code, a street address, a street number, a building name, a country, a postal code, latitude and longitude, or other information related to a location. For an embodiment, a shipping options module 208 is configured to determine the shipping options available to deliver merchandise to a location, such as a merchandise destination location received from a user device 102. Shipping options, according to an embodiment, may be a predetermined list or may be generated in response to a request received from a user device 102.

As discussed above, shipping options include, but are not limited to, carrier service, shipping speed, packaging, conditions on shipping, or other aspects related to the shipping of merchandise. For an embodiment, a shipping options module 208 may determine shipping options based on input from a rule module 210. According to an embodiment, a rule module 210 is configured to determine one or more rules based at least in part on information received from a user device 102. Information received from a user device 102 may include location information, information related to merchandise, information related to shipping options, information related to delivery dates, or other information related to merchandise or services offered by a system 202. For an embodiment, a rule module 210 is configured to determine one or more rules based on business aspects including, but not limited, a preferred shipping location, a preferred warehouse, a preferred warehouse state, a preferred shipping option, a price, a gross margins, a profit margin, a minimum quantity, a cost of shipping, a shipping rule based on merchandise origin locations, a shipping rule based on merchandise destination location, a user preference, a user history, a shipping time to a merchandise destination location, a temperature limit, a number of points or locations to determine weather conditions between a merchandise origin location and a merchandise destination location, a merchandise destination location, and other factors related to shipping merchandise.

According to an embodiment, a rule module 210 is configured to receive information related to the location of merchandise, the user device location, the shipping destination and/or other information related to shipping. A rule module 210 references one or more database 216 or lookup table, according to some embodiments, that includes rules or conditions used to determine available shipping options. According to some embodiments, a database 216 or lookup table may include one or more rules that correspond to one or more references or values. For some embodiments, a reference or value includes a pointer or address location of a list of available shipping options. For some embodiments, a database 216 or lookup table may be any one or a combination of one or more memories, one or more servers within system 202, or one or more servers remotely located from system 202. According to other embodiments, rule module 210 may access more than one database 216 or lookup table. Yet another embodiment includes a rule module 210 accessing a database 216 that includes a list of available shipping options preconfigured based on one of or a combination of a shipping destination and a type of merchandise being shipped.

A rule module 210, according to some embodiments, may be configured to take into account federal regulations, state regulations, county regulations, business rules, regional preferences or other criteria for selecting available shipping options. For some embodiments, a rule module 210 is configured to include state and/or county alcohol regulations including, but not limited to, price requirements, shipping requirements, quantity requirements, alcohol content requirements, and other requirements related to selling and distributing alcohol. According to some embodiments, a rule module 210 is configured to include business rules related to aspects including, but not limited to, preferred carrier services, preferred shipping options, preferred shipping locations, price, gross margins, minimum quantities, cost of shipping, shipping rules based on merchandise origin locations, shipping rules based on destination, user preferences, or user history, or other factors related to the business.

The embodiment illustrated in FIG. 2 also includes a date determination module 211. According to an embodiment, a date determination module 211 is configured to determine one or more dates of delivery for merchandise. A Date determination module 211, according to an embodiment, is coupled with a shipping options module 208 and a rule module 210. As such, a date determination module 211 may receive input from a shipping options module 208 that indicates the determined shipping options available to a user device 102. For an embodiment, a date determination module 211 may receive input from a rule module 210 that indicates the nominal shipping times for the determined shipping options. Based on one or more inputs, a date determination module 211 etermines one or more delivery dates for one or more items of merchandise selected for shipping.

An embodiment of a system 202 may optionally include a weather module 213, as illustrated in FIG. 2. According to an embodiment, a weather module 213 is configured to receive one or more rules from rule module 210. Such rules may include, but are not limited to, rules for shipping one or more types of merchandise during certain weather conditions, duration of shipping one or more types of merchandise for a given weather conditions, shipping routes, merchandise origin location, merchandise destination location, and other rules related to shipping one or more types of merchandise based on weather conditions. A weather module 213 may also be configured to receive weather information. For example, such weather information may provide current weather conditions, predicted weather conditions over a period of time, or other weather related information. According to an embodiment, a weather module 213 is configured to request weather information from a weather system or a weather database. Such a weather system or weather database may be included in a system 202 or may be remotely located. For some embodiments, a weather module 213 is configured to request weather information by sending a request over a communication network 204 using communication protocols including those described herein.

According to an embodiment, a weather module 213 may be configured to request weather information using an application programming interface (“API”) including, but not limited to, Simple Object Access Protocol (“SOAP”), Representational State Transfer (“REST”), Java API, Portable Operating System Interface (“POSIX”), Microsoft Windows API, or other APIs. For some embodiments, a weather module 214 may send a SOAP request over a communication network 204 to a weather database. The weather database would then send a corresponding SOAP response including the requested weather information. An example of a weather database for obtaining weather information includes, but is not limited to, the National Weather Service National Digital Forecast Database.

For some embodiments, a weather module 213 may request weather information for many points along a shipping route. According to an embodiment, a weather module 213 configured to request weather information for the merchandise origin location and the merchandise destination location. For an embodiment, a weather module 213 receives merchandise destination location from a shipping options module 208. Another embodiment includes a weather module 213 configured to receive a merchandise destination location from a user 102. A weather module 213, for an embodiment, receives merchandise origin location from a rule module 210.

Some embodiments include a weather module 213 configured to request weather information over one or more points over a shipping route. Other embodiments include a weather module 213 configured to request weather information over one or more points along a line connecting the merchandise origin location and the merchandise destination location. For an embodiment, a rule module 210 is configured to determine one or more points based on a merchandise origin location and a merchandise destination location and to transmit these points to a weather module 213. Yet another embodiment includes a rule module 210 configured to include one or more points that correspond to one or more merchandise destination locations. For such and embodiment, a rule module 210 is further configured to transmit one or more points that correspond to a received merchandise destination location to a weather module 213 upon receiving a merchandise destination location. As such, a weather module 213 is configured to determine weather conditions for all points or locations received from the rule module, for an embodiment.

For some embodiments, a weather module 213 may request weather information over a period of time that the merchandise is expected to be in transit. According to an embodiment, a weather module 213 may request weather information over a period of time before and after a selected delivery date. For example, a weather module 213 may request weather information for a period of time including 5 days before and after a selected delivery date, 10 days before and after a selected delivery date, 20 days before and after a selected delivery date, or any other period of time.

According to an embodiment, a weather module 213 is configured to determine if one or more temperatures for a destination location, a shipping location, and/or one or more intermediary locations exceeds a temperature limit or threshold. The temperature limit may be chosen based on the type of merchandise to ship or may be set for all merchandise. According to an embodiment, a weather module 213 may receive one or more temperature limits from a rule module 210. For some embodiments, a weather module 213 is configured to determine if one or more temperatures for a merchandise destination location, a merchandise origin location, and/or one or more intermediary locations exceeds and/or is within one or more temperature ranges. For example, an embodiment includes a weather module 213 configured to determine if a temperature for one or more locations is greater than a first temperature limit, less than the first temperature limit but greater than a second temperature limit, or less than the second temperature limit.

According to another embodiment, a weather module 213 is configured to determine if a temperature for one or more locations is greater than a first temperature limit or less that the first temperature limit but greater than a second temperature limit. For an embodiment, the first temperature limit may be set to 105 degrees Fahrenheit and the second temperature is set to 90 degrees Fahrenheit. Another embodiment includes the first temperature limit set to 90 degrees Fahrenheit and the second temperature set to 80 degrees. For yet another embodiment, the first temperature limit may be set to 35 degrees Fahrenheit and the second temperature may be set to 27 degrees Fahrenheit. Embodiments are not limited to the number of temperature limits used, the value of the temperature limits used for the temperature limits, or a temperature scale.

For an embodiment, a weather module 312 is configured to transmit one or more outputs to one or more modules in response to determining a temperature at one or more locations. A weather module 312 may be configured to transmit an output to a shipping options module 208 in response to determining one or more of the temperature limits is met or exceeded, according to an embodiment. For another embodiment, a weather module 312 is configured to transmit a weather alert to a shipping options module 208 in response to determining one or more location temperatures is within, below, or above one or more temperature limits. The output from a shipping options module 208 may be a weather alert which may include, but is not limited to, setting a variable, writing a value into memory, calling a function, running a script, changing a voltage or current level, or any other technique to indicate a certain condition had been determined.

A shipping options module 208 may also be configured to update shipping options responsive to receiving the weather alert from a weather module 208. For example, a weather module 213 may determine that one or more location temperatures exceed a temperature limit. In response, a weather module 213 generates a weather alert that indicates a condition is met or exceeded. A shipping options module 208 upon receiving the weather alert may generate new shipping options or update previously determined shipping options. For an example, shipping options module may update previously determined shipping options by generating a list of available shipping options in response to receiving a weather alert. According to an embodiment weather safe options may include holding merchandise until a weather module 213 determines one or more temperatures are within a range, are below, or above one or more temperature limits, adding insulation to packaging materials, adding ice packs, limiting the shipping options to those with a shipping duration determined acceptable, or other option to limit exposure of merchandise to certain weather conditions. An example of limiting shipping duration is to provide options that limit the duration of shipping to less than a week including, but not limited to, one or more of 3 day shipping, 2 day shipping, and overnight shipping.

For an embodiment, a date determination module 211 is configured to receive a weather alert transmitted by weather module 213. According to an embodiment, the weather alert includes an indication that one or more dates include certain weather conditions as determined by a weather module 213. For an embodiment a weather alert may include a list of all dates that the determined weather condition exists. The date determination module 211, according to an embodiment, in response to receiving a weather alert may generates a new list of available delivery dates. According to an embodiment, a date determination module 211 may update a list of available deliver dates to exclude delivery dates that would expose merchandise a weather condition.

For another embodiment, a date determination module 211 may generate format or presentation information responsive to the weather alert from a weather module 213 to indicate one or more delivery dates would expose merchandise to a weather condition. According to an embodiment, the format or presentation information includes, but is not limited to, markup language, cascading style sheets (“CSS”), templates, or other ways of assigning presentation formats to information. Another embodiment includes a date determination module 211 including an indication with the determined dates. Such an embodiment may include a list of dates with a weather alert indicated by setting one or more variables, flags, bits, or another technique used to link data.

According to an embodiment as illustrated in FIG. 2, a system 202 includes an update module 214. According to an embodiment, an update module 214 is coupled with one or more modules including, but not limited to, a shipping options module 208, a rule module 210, a date determination module 211, and a weather module 213. An update module 214, according to an embodiment, is configured to receive information from one or more of the modules. For example, delivery date information may be received from a date determination module 211 in one or more formats including those discussed herein. Further, weather information, as described herein, may be received from weather module 213. In addition, shipping options information may be received from shipping options module 208.

According to another embodiment, an update module 214 is configured to aggregate information from one or more of modules. An update module 214 may aggregate information from one or more modules by using techniques including, but not limited to, generating pointers to all information stored in one or more memories, creating a document to include all information, writing all the information into memory, appending new information to information previously generated, and other techniques for gathering and storing information.

According to an embodiment as illustrated in FIG. 2, an online shopping system 202 includes an update module 214. According to an embodiment, update module 214 is coupled with a rule module 210 and is configured to receive rule information from rule module 210. According to some embodiments, rule information may include, but is not limited to, a variable, a pointer, an address, a reference, a function call or other information that corresponds to one or more rules to apply. Based on the received rule information from a rule module 210, an update module 214 determines the content information to send to a user device 102. According to an embodiment, an update module 214 performs a search of a database of weather information, shipping information, or merchandise information that corresponds to the rule information to generate a set of information to transmit to a user device 102. For another embodiment, information may be preselected and associated with rule information from a rule module 210. Such an embodiment would access the set of information, for example by retrieving the information from a memory, a database, or an external server, to form content information. For some embodiments, an update module 214 may exclude information aggregated from the one or more modules or included in a database based on rule information received from a rule module 210 to form content information.

A system 202, according to the embodiment illustrated in FIG. 2, includes a format module 212 coupled with an update module 214. According to an embodiment, a format module 212 is configured to receive aggregate information from update module 214. An update module 214 may be received in one or formats including those discussed herein. A format module 212, according to an embodiment, is configured to transform the aggregate information into a format for a user device 102. For one example, a format module 212 may transform content from a database format into a markup language format for viewing on a client application, such as a web browser, on a user device 102. For some embodiments, a format module 212 converts the aggregate information received from update module 214 into a compatible version of HTML or XHTML for a client application 104.

According to some embodiments, a format module 212 is configured to append some or all of the aggregated information received from an update module 214 with cascading style sheets, scripts, or other format information to instruct a client application 104 how to display or format the information. A format module 212, according to an embodiment, may determine changes in aggregate information received from update module 214 based on one or more sets of information previously transmitted to a user device 102. As such, a format module 212 may prepare the updated or changed information from the previously sent information into a format for the client application. According to an embodiment, a format module 212 determines any changes in content information from a set previously sent to a user device 102 based on a cookie, token, log, or other record of content information transmitted to a user device 102.

For an embodiment, a format module 212 may be configured to receive information from one or more of the modules in system 202. For example, a format module 212 may be configured to receive determined shipping options from a shipping options module 208, weather information from a weather module 213 and/or delivery dates from a date determination module 211. A format module 212 is configured to transform the information received from the one or more modules using techniques discussed herein. The formatted information, according to an embodiment, is then transmitted to a communication interface 206 for transmission to one or more clients 102. Thus, according to an embodiment, a user device 102 would receive the formatted information for viewing as a webpage or section of a webpage on a user device 102.

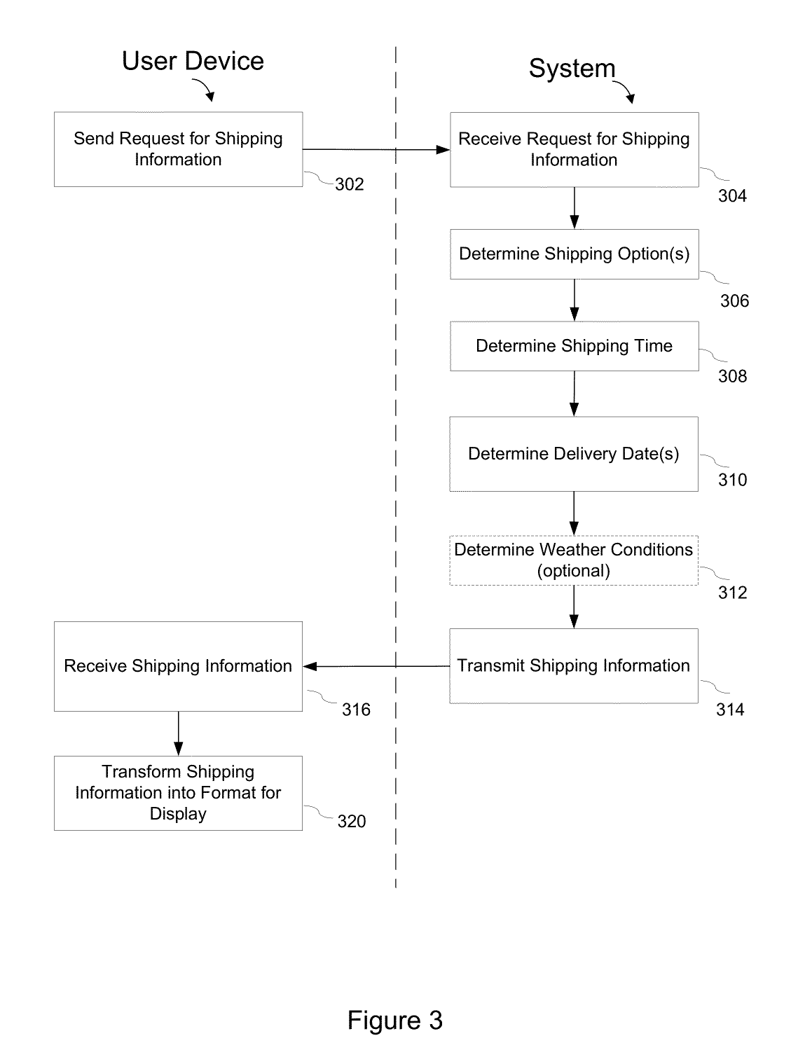

FIG. 3 illustrates a flow diagram for determining shipping information according to an embodiment. At block 302, a user device sends a request for shipping information 302. Such a request includes, but is not limited to, requesting a URL to view a webpage such as a shopping cart page, accessing an FTP site, or merchandise for purchase, and otherwise accessing a resource on a remote system. As discussed above, the request may be generated by a client application 102 responsive to user input, for example entering a URL, selecting a button, or through another technique for a user to interface with a user device or application. The system receives the request at block 304. In response to the received request, a system determines shipping options at block 306 using techniques, such as those discussed herein.

At block 308, a system according to an embodiment determines the shipping time necessary for delivering merchandise. The system may also determine one or more delivery dates for merchandise using techniques discussed herein, according to an embodiment at block 310. At block 312, a system may optionally determine one or more weather conditions including, but not limited to, weather conditions for the determined delivery date, weather conditions for a period of time around a determined delivery date, and weather conditions over shipping routes for the duration of shipment. Some embodiments of a system determine weather conditions using techniques discussed herein. At block 314, a system, according to an embodiment, transmits the shipping information that may include at least one of the determined shipping options, the determined shipping time, the determined delivery dates, and the determined weather conditions using techniques discussed herein. According to some embodiments, the shipping information is transmitted with information for generating a document on a user device, such as HTML, XHTML, pictures and/or other instructions that instruct a client application to generate a document for viewing on a user device. A user device receives the shipping information at block 316. The shipping information is transformed into a format for display at block 320 using techniques discussed herein.

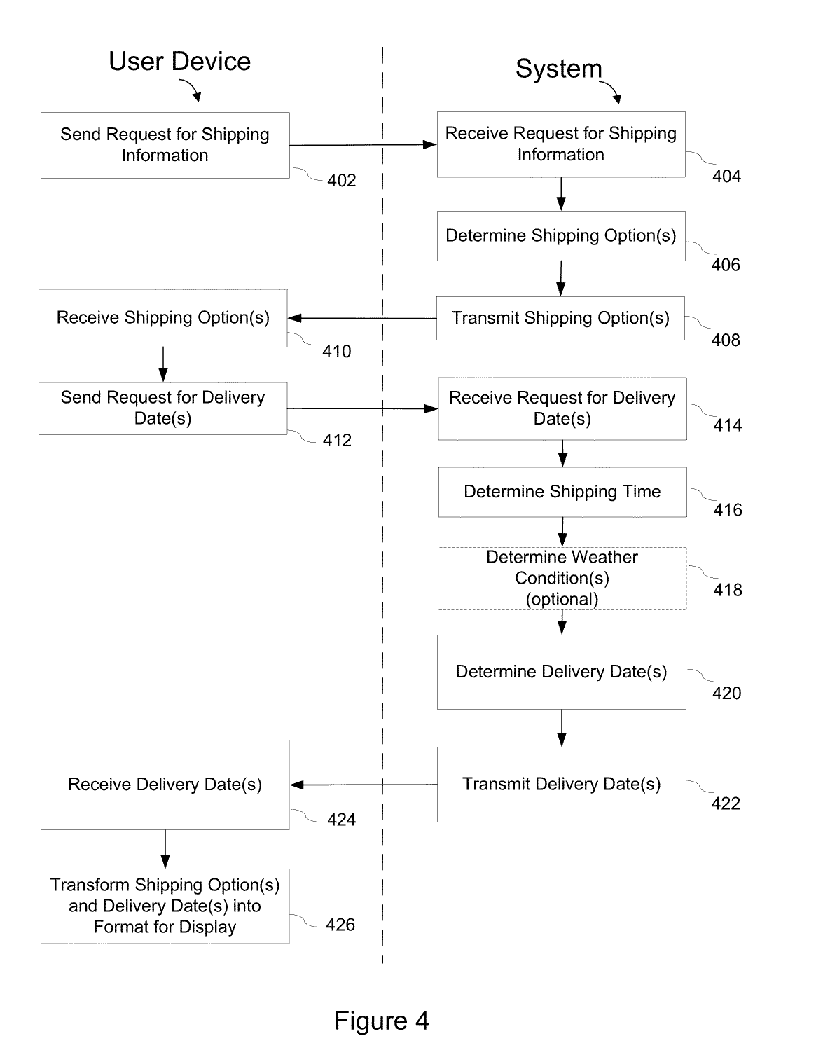

FIG. 4 illustrates a flow diagram for determining shipping information and determining delivery dates according to an embodiment. At 402, a user device 102 sends a request for shipping information using techniques as discussed herein. A system 202 receives the request for shipping information at block 404. Responsive to the request for shipping information, at block 406, a system determines shipping options as discussed herein. According to an embodiment, a system transmits shipping options determined by the system to a user device at block 408. For some embodiments, transmitting shipping options includes formatting shipping options, for example by using techniques discussed herein. At block 410, a user device receives the shipping options. According to some embodiments, receiving the shipping options includes transforming the shipping options received from the system for display on a user device using techniques discussed herein.

At block 412, user device sends a request for one or more delivery dates using techniques discussed herein. For an embodiment, sending a request for one or more delivery dates is in response to receiving the shipping options. According to some embodiments, sending a request for one or more delivery dates is responsive to a user input. For example, a user input may include, but is not limited to, selecting one or more shipping options, selecting an icon or button, or other user interaction with a user device or application. A system receives the request for one or more delivery dates at block 414 and responsive to the request determines the shipping time of one or more merchandise, such as using techniques described herein. A system, at block 418, optionally determined weather conditions as discussed herein. At block 420, a system determines one or more delivery dates using techniques discussed herein. The one or more determined delivery dates are transmitted at block 422, for example by using techniques discussed herein. According to some embodiments, transmitting one or more delivery dates includes formatting delivery dates, such as using techniques as discussed herein. A user device receives the one or more delivery dates at block 424 and transforms the one or more delivery dates into a format for display at block 426, for example by using techniques discussed herein.

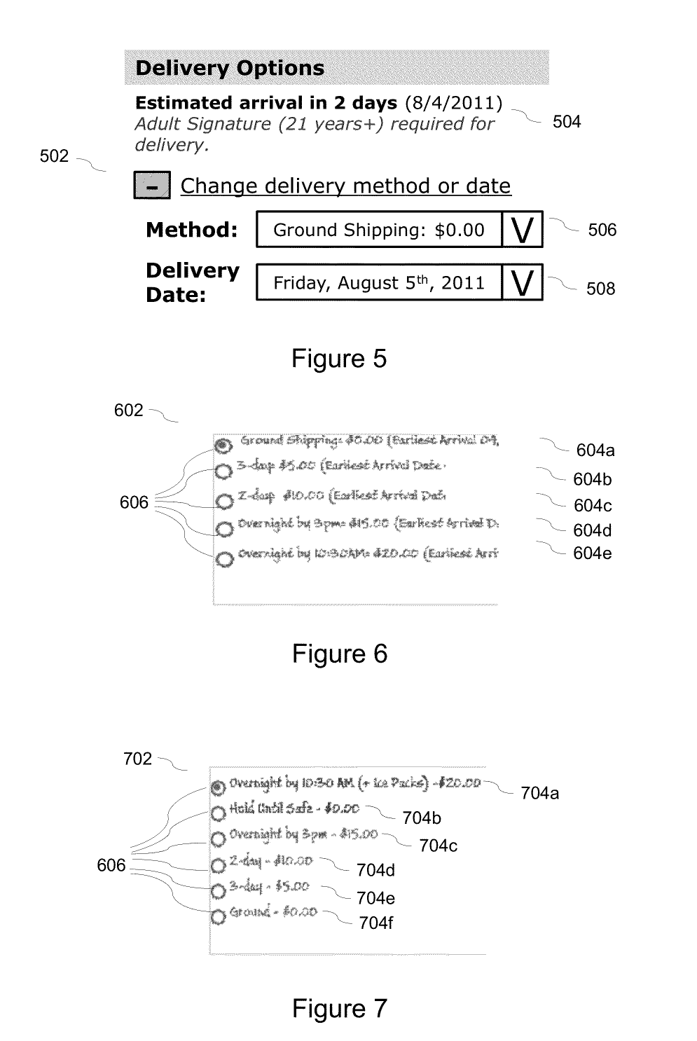

FIG. 5 illustrates an embodiment of a document 502 generated to display determined shipping options and one or more determined delivery dates. The document 502 includes content information 504 that may include, but is not limited to, one or more estimated arrival dates, legal information, product information, shipping information, or information related to shipping or delivery of merchandise. Content information, according to an embodiment, is generated based on one or more business rules. According to an embodiment the content information generated may include product information based on one or more business rules determined based on location information. For example, content information 504 may provide availability information of a product currently in inventory based on a business rule requiring the predetermined profit margin be above a threshold for the determined location. Content information 504 may be generated, in whole or in part, based on one or more business rules that the product is available in a preferred shipping location for the determined location, according to an embodiment. Another example includes content information 504 which may be generated based one or more business rules that provide the viewing of products that can be obtained, for example from business partners, but is not currently in inventory. In some embodiments, product information, such as content information 504, may include information of products available regardless of determined location.

For an embodiment, document 502 also includes one or more shipping options 506 displayed as a drop-down menu. Some embodiments include displaying shipping options 506 in the format of a list, a grid, a window, or any other manner for presenting information. Shipping options 506, according to an embodiment, are determined shipping options received from a system using techniques as discussed herein. For some embodiments, the format of shipping options 506 displayed in document 502 is based on format information received with the determined shipping options from a system using techniques discussed herein. Another embodiment includes the format of shipping options 506 displayed in a document 502 based on format information of an application on a user device.

As illustrated in the embodiment in FIG. 5, a document 502 also includes a one or more delivery dates 508 displayed as a drop-down menu. Some embodiments include displaying delivery dates 508 in the format of a list, a grid, a window, or any other manner for presenting information. Delivery dates 508, according to an embodiment, are determined delivery dates received from a system using techniques as discussed herein. For some embodiments, the format of delivery dates 508 displayed in document 502 is based on format information received with the determined delivery dates from a system using techniques discussed herein. Another embodiment includes the format of delivery dates 508 displayed in a document 502 based on format information of an application on a user device.

For some embodiments, a document 502 is configured such that a user may select one or more delivery dates and/or one or more delivery dates displayed. According to an embodiment, a user may select one or more delivery dates and/or one or more deliver dates by using a user interface. A document 502, according to an embodiment, is configured such that a user selection is transmitted back to a server or system using techniques discussed herein.

FIG. 6 illustrates a list of determined shipping options and delivery options 602 according to an embodiment. Such a list includes both merged determined shipping options and determined delivery dates for each list element 604a-e. For some embodiments, a user device is configured to transform determined shipping options and determined delivery date information received from a system to merge related shipping options information and delivery date information into a single list element 604a-e. According to other embodiments, a system is configured to transmit merged shipping options information and delivery date information in a format or with format information using techniques described herein such that a user device displays a list that includes both shipping options and delivery date information as a single list element 604a-e. The embodiment of a list of determined shipping options and delivery options 602 as illustrated in FIG. 6 also includes selectable fields 606 each corresponding to a list element 604a-e. A selectable field 606 includes, but is not limited to, a radio button, a check box, a button, and other selectable features. According to an embodiment, a selectable field 606 is configured to respond to user input through a user interface. For some embodiments, list element 604a-e is configured to respond to user input through a user interface, such as being a selectable list element.

FIG. 7 illustrates an embodiment of a list including determined shipping information based on determined weather conditions 702. The list includes list elements 704a-f that, according to an embodiment, includes determined shipping options with one or more based on determined weather conditions. An example of a list element that includes determined shipping options based on determined weather conditions is list element 704a that displays the option of overnight shipping with ice packs. Another example of a list element that includes determined shipping options based on determined weather conditions includes list element 704b that displays the hold until safe option. The embodiment illustrated in FIG. 7 also includes selectable fields 606 as discussed above.

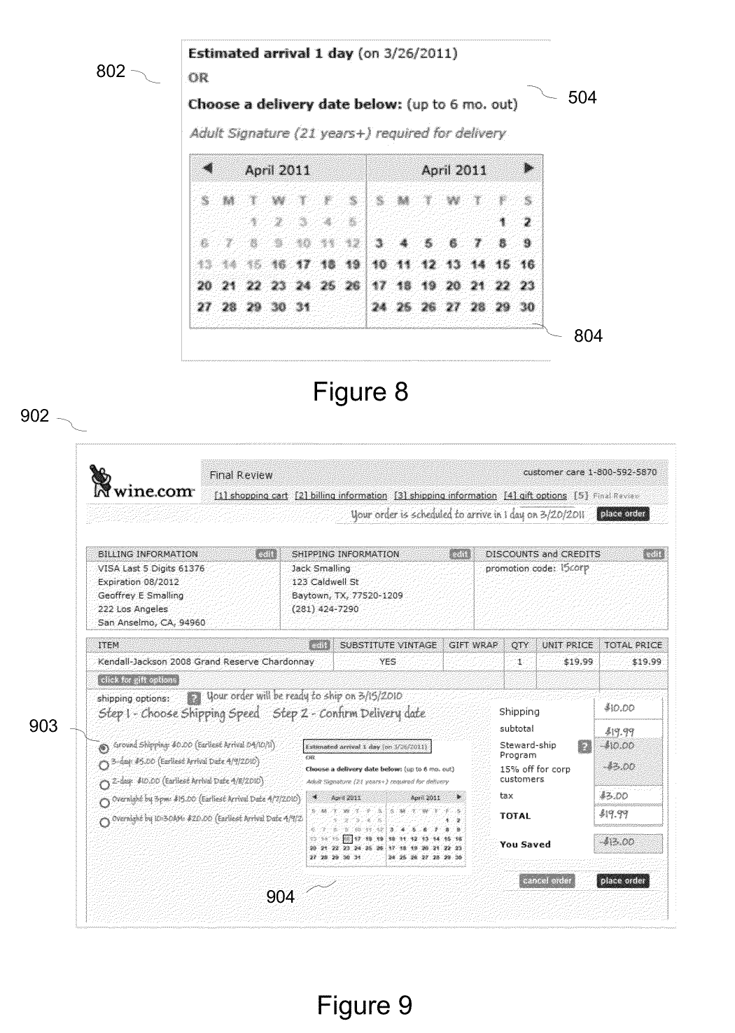

FIG. 8 illustrates a graphic user interface (“GUI”) for selecting a delivery date 802 according to an embodiment. The graphic user interface for selecting a delivery date 802, according to an embodiment, includes content information 504, as discussed herein. According to an embodiment, a graphic user interface for selecting a delivery date 802 includes a selectable field 804 configured to receive user input through a user interface to select a delivery date. For an embodiment as illustrated in FIG. 8, selectable field 804 is configured as a calendar. According to some embodiment, selectable field 804 includes one or more determined delivery dates. Determined delivery dates may be determined by a system using one or more techniques discussed herein. For some embodiments, dates available for delivering merchandise are displayed using different formatting to visually distinguish available dates from the unavailable dates. Formatting used to display available date for delivering merchandise includes, but is not limited to, font, color, borders, shading, and other indicators to set available dates apart from the other dates. According to embodiments, graphic user interface for selecting delivery dates 802 is generated using techniques discussed herein.

FIG. 9 illustrates a graphic user interface for a shopping cart 902 that includes determined shipping information according to an embodiment. According to an embodiment, determined shipping information is integrated into a document such as a GUI for a shopping cart 902 used for purchasing merchandise. FIG. 9 illustrates a GUI that includes determined shipping information integrated into the GUI as a list of determined shipping options and delivery options 903 and a GUI for selecting a delivery date 904 using techniques as described herein. As such, a system may provide to an application determined shipping information and/or format information to use to generate a GUI that integrates the information into a document.

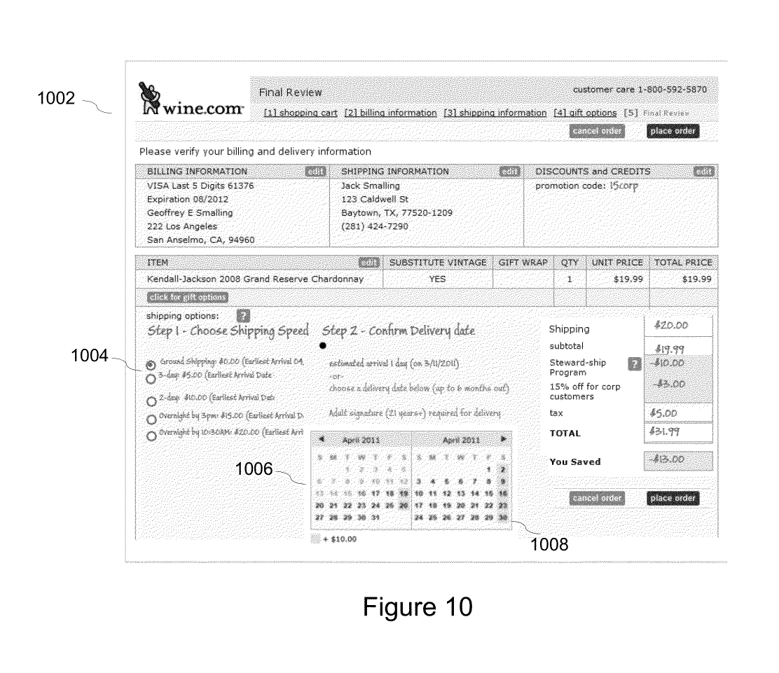

FIG. 10 illustrates a GUI for a shopping cart that includes determined shipping information with format information based on business rules 1002. The GUI of FIG. 10 includes determined shipping information integrated into a document as a list of determined shipping options and delivery options 1004 and a GUI for selecting a delivery date 1006. For an embodiment, a system generates the determined shipping information with format information based on business rules 1002 using techniques described herein. For example, formatting based on business rules 1008 may be generated from format information based on business aspects of shipping such as pricing for shipping options. As illustrated in FIG. 10, GUI for selecting a delivery date 1006 includes formatting based on business rules 1008 to indicate a price difference from other available delivery dates.

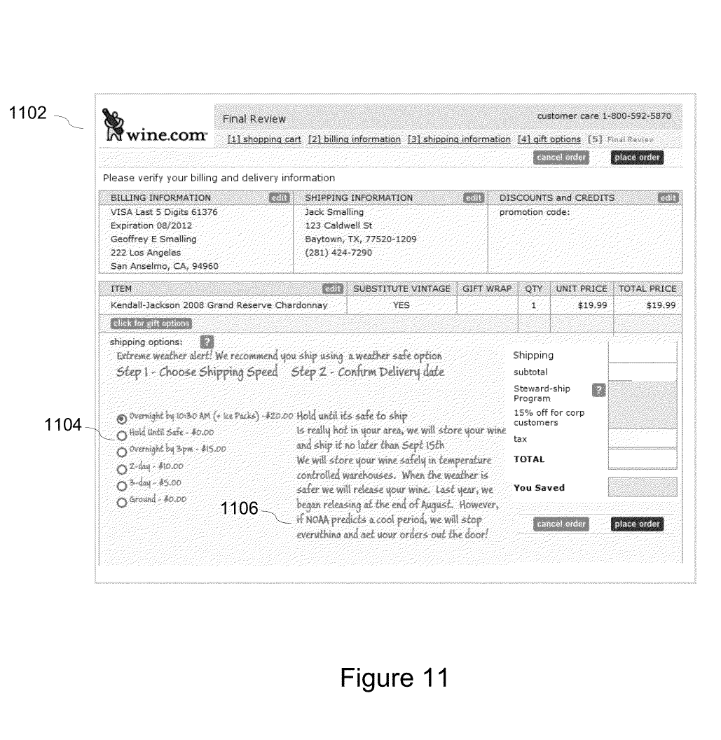

FIG. 11 illustrates a GUI for a shopping cart that includes determined shipping information based on determined weather conditions 1102. The GUI of FIG. 11 includes a list of determined shipping options based on weather conditions 1104 and content information based on weather conditions 1106. For an embodiment, a system determines weather conditions using techniques described herein and then based on the determined weather conditions generates a list of determined shipping options using techniques discussed herein. For an example, the list of determined shipping options based on determined weather conditions 1104 may include shipping options including ice packs and hold until safe to ship options if the weather condition is determined to be beyond a threshold. A system, as described herein, may also generate content information based on determined weather conditions 1106 using techniques discussed herein. For example, if the determined weather condition is exceeds a threshold, the system may generate content information that describes the weather condition and the options available to a user with regard to the merchandise selected for shipping.

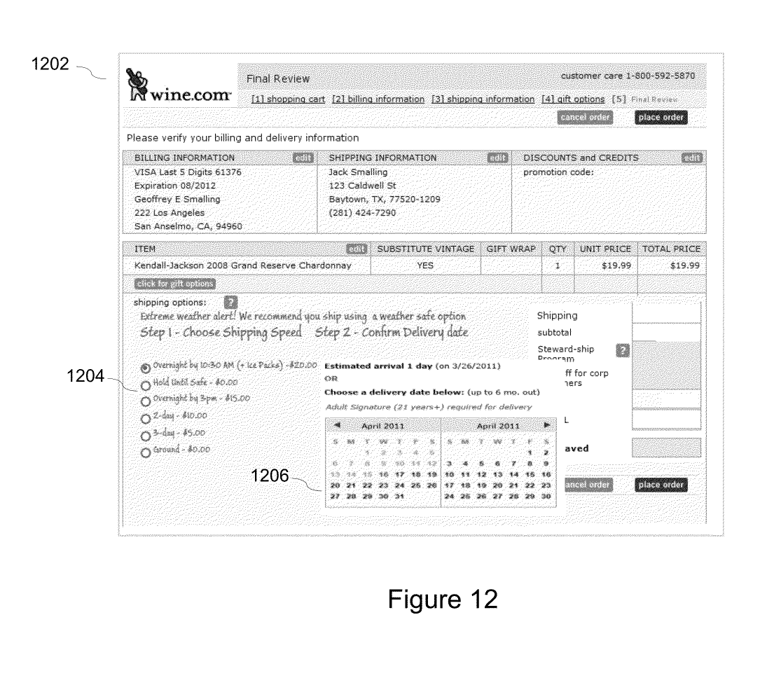

FIG. 12 illustrates a GUI for a shopping cart that includes determined shipping information and a graphic user interface based on determined weather conditions 1202. The GUI of FIG. 12 includes a list of determined shipping options based on weather conditions 1204 generated by an embodiment of a system described herein. For an example, the list of determined shipping options may include shipping options available based on a determination that the weather conditions are beyond a threshold as determined by an embodiment of a system using techniques as discussed herein. In addition, the list of determined shipping options may also include content information such as pricing information corresponding to a shipping option. The GUI of FIG. 12 also includes a graphic user interface for selecting a delivery date 1206 generated by an embodiment of a system described herein. For an embodiment, the GUI for selecting a delivery date may be a pop-up window that is generated or displayed responsive to a user input that selects at least one shipping option from the list of shipping options based on one or more weather conditions 1204. Such a GUI may be configured to generate or display a pop-up window based on format information received from an embodiment of a system as described herein. For another embodiment, GUI may include a pop-up window generated based on format information included in an application for a user device. Format information used to generate a pop-up window, according to an embodiment, includes but is not limited to, a script, code, and a call to an external application.

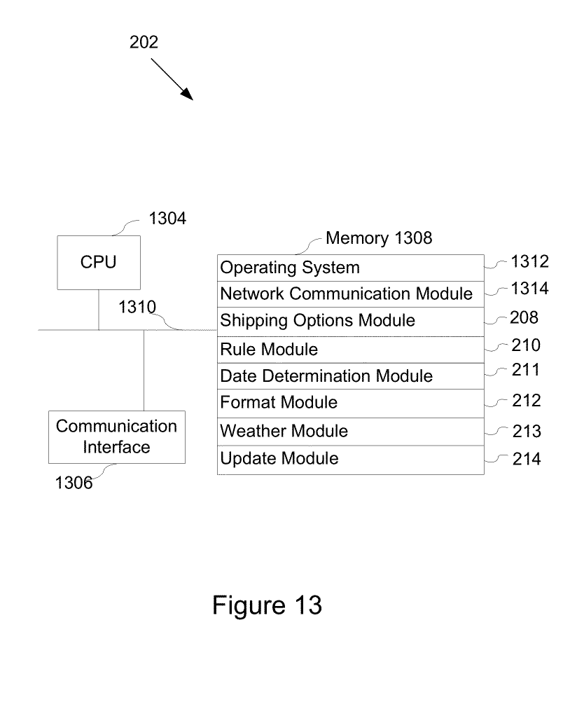

FIG. 13 illustrates an embodiment of a system 202 that implements the methods and techniques described herein. The system, according to an embodiment, includes one or more processing units (CPUs) 1304, one or more networks or other communication interfaces 1306, a memory 1308, and one or more communication buses 1310 for interconnecting components and modules. The system 202 may optionally include a user interface comprising a display device and a keyboard (not shown). The memory 1308 may include high speed random access memory and may also include non-volatile memory, such as one or more magnetic or optical storage disks. The memory 1308 may include mass storage that is remotely located from CPUs 1304. Moreover, memory 1308, or alternatively one or more storage devices (e.g., one or more nonvolatile storage devices) within memory 1308, includes a computer readable storage medium. The memory 1308 may store the following elements, or a subset or superset of such elements:

an operating system 1312 that includes procedures for handling various basic system services and for performing hardware dependent tasks;

a network communication module (or instructions) 1314 that is used for connecting the system 202 to other computers, clients, systems or devices via the one or more communication interfaces 1306 (wired or wireless), such as the Internet, other wide area networks, local area networks, metropolitan area networks, and other type of networks;

a shipping options module 208 for determining one or more shipping options as described herein;

a rule module 210 for determining one or more rules as described herein;

a date determination module 211 for determining one or more delivery dates as described herein;

a format module 212 for transforming shipping information and content information into a format for a user device as described herein;

a weather module 213 for determining weather conditions as described herein; and

an update module 214 for generating and/or aggregating information as described herein.

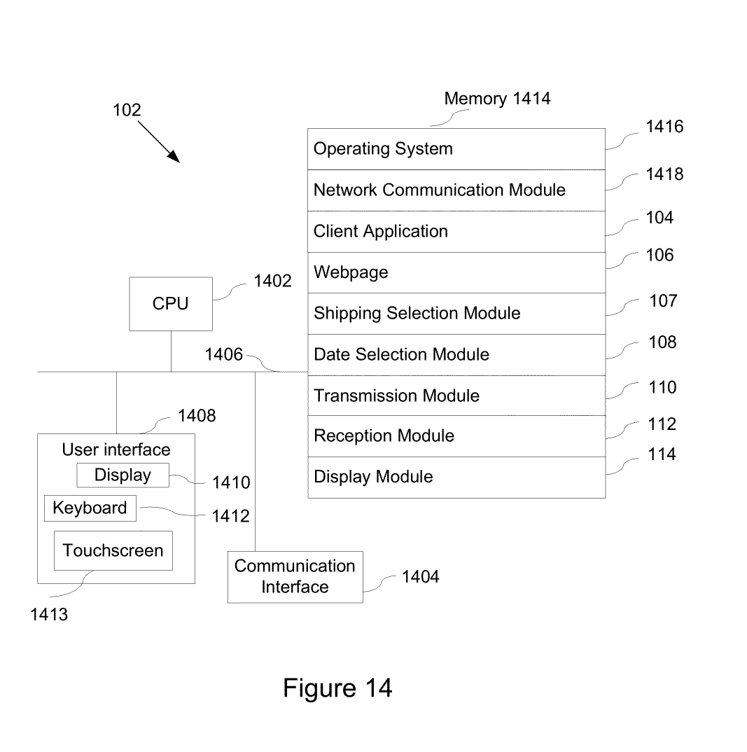

FIG. 14 illustrates an embodiment of a client or user device 102 that implements the methods described herein. The client, according to an embodiment, includes one or more processing units (CPUs) 1402, one or more network or other communication interfaces 1404, memory 1414, and one or more communication buses 1406 for interconnecting these components. The user device 102 may optionally include a user interface 1408 comprising a display device 1410, a keyboard 1412, touchscreen 1413, and/or other input/output devices. Memory 1414 may include high speed random access memory and may also include non-volatile memory, such as one or more magnetic or optical storage disks. The memory 1414 may include mass storage that is remotely located from CPUs 1402. Moreover, memory 1414, or alternatively one or more storage devices (e.g., one or more nonvolatile storage devices) within memory 1414, includes a computer readable storage medium. The memory 1414 may store the following elements, or a subset or superset of such elements:

an operating system 1416 that includes procedures for handling various basic system services and for performing hardware dependent tasks;

a network communication module (or instructions) 1418 that is used for connecting the user device 102 to other computers, clients, systems or devices via the one or more communication network interfaces 1404 and one or more communication networks, such as the Internet, other wide area networks, local area networks, metropolitan area networks, and other type of networks;

a client application 104 including, but not limited to, a web browser, a document viewer or other application for viewing information;

a webpage 106 as described herein;

a shipping selection module 107 for requesting shipping options and receiving input as described herein;

a date selection module 108 for requesting delivery dates and receive input as described herein;

a transmission module 110 for transmitting and/or transforming a request as described herein;

a reception module 112 for receiving content information as described herein; and

a display module 114 for transforming content information into a format for viewing on a user device as described herein.

Although FIGS. 13 and 14 illustrate a client system 102 and a server system 202, the figures are intended more as functional descriptions of the various features which may be present in a client and a set of servers than as a structural schematic of the embodiments described herein. As such, one of ordinary skill in the art would understand that items shown separately could be combined and some items could be separated. For example, some items illustrated as separate modules in FIG. 13 could be implemented on a single server and single items could be implemented by one or more servers. The actual number of servers or modules used to implement server system 202 and how features are allocated among them will vary from one implementation to another, and may depend in part on the amount of data traffic that the system must handle during peak usage periods as well as during average usage periods. In addition, some modules or functions of modules illustrated in FIG. 13 may be implemented on one or more one or more servers remotely located from other servers that implement other modules or functions of modules illustrated in FIG. 13.

In the foregoing specification, specific exemplary embodiments of the invention have been described. It will, however, be evident that various modifications and changes may be made thereto. The specification and drawings are, accordingly, to be regarded in an illustrative rather than a restrictive sense.

What is claimed is:

1. A system to determine shipping information comprising:
memory;
one or more processors; and
one or more modules stored in memory and configured for execution by the one or more processors, the modules comprising:
a shipping options module configured to determine at least one shipping option based on an input received from a user device;
a date determination module coupled with said shipping options module, said date determination module configured to determine at least one delivery date of a shipment responsive to said input; and
a format module configured to transform said at least one shipping option and said at least one delivery date into a format for said user device.

2. The system of claim 1 further comprising a weather module configured to determine a weather condition responsive to said input.

3. The system of claim 1, wherein said input is generated in response to a user selection on said user device.

4. The system of claim 1, wherein said input is generated in response to a user selecting merchandise for purchase.

5. The system of claim 2, wherein said weather module is configured to determine a plurality of weather conditions.

6. The system of claim 2, wherein said weather module is configured to determine said weather condition based on said at least one delivery date of a shipment.

7. The system of claim 6, wherein said weather module is further configured to determine said weather condition based on said at least one shipping option.

8. The system of claim 1, wherein said date determination module is further configured to determine said at least one delivery date based on said at least one shipping option.

9. The system of claim 1 further comprising a rule module configured to determine at least one rule responsive to said input.

10. The system of claim 9, wherein said date determination module is further configured to determine said at least one delivery date also based on said at least one rule.

11. The system of claim 9, wherein said shipping option module is further configured to determine said at least one shipping option also based on said at least one rule.

12. The system of claim 1, wherein said input includes information corresponding to a type of merchandise and a merchandise destination location.

13. The system of claim 9, wherein said rule module generates a merchandise origin location based on said input.

14. A retail system to determine shipping options for merchandise comprising:
memory;
one or more processors; and
one or more modules stored in memory and configured for execution by the one or more processors, the modules comprising:
a shipping options module said shipping option module configured to determine at least one shipping option based on an input received from a user device;
a date determination module coupled with said shipping options module, said date determination module configured to determine at least one date for delivery of a shipment responsive to said input;
a weather module coupled with said date determination module, said weather module configured to determine at least one weather condition responsive to said input; and
a format module to transform said content information into a format for said user device.

15. The retail system of claim 14, wherein said weather module is further configured to determine if said at least one weather condition exceeds a temperature limit.

16. The retail system of claim 14, said weather module is further configured to generate a weather alert based on said at least one weather condition.

17. The retail system of claim 16, wherein said weather module is configured to generate said weather alert upon a determination that said weather condition includes a temperature above a temperature limit.

18. The retail system of claim 17, wherein said temperature limit is 90 degrees Fahrenheit.

19. The retail system of claim 16, wherein said weather module is configured to generate said weather alert upon a determination that said weather condition includes a temperature below a temperature limit.

20. The retail system of claim 19, wherein said temperature limit is 35 degrees Fahrenheit.

21. The retail system of claim 16, wherein said date determination module generates a list of available delivery dates in response to said weather alert.

22. The retail system of claim 16, wherein said shipping options module is further configured to generate a list of available delivery dates in response to said weather alert.

23. The retail system of claim 21, wherein said date determination module generates format information in response to said weather alert.

24. A method for determining shipping information for a merchandise comprising:
while executing a client application on a user device,
sending a request for shipping information to a system configured to determine a shipping information;
in response to said request for shipping information, receiving at least one shipping option based on information related to a merchandise; and
transforming said at least one shipping option based on information related to said merchandise into a format for displaying on said user device.

25. The method of claim 24, wherein said client application is a web browser.

26. The method of claim 24, wherein transforming said at least one shipping option based on information related to said merchandise into said format for displaying on said user device includes rendering markup language for viewing on said user device.

27. The method of claim 24 further including:
sending a second request for at least one delivery date for said merchandise; and
in response to sending said second request, receiving at least one delivery date for said merchandise.

28. The method of claim 24, wherein said at least one shipping option is determined based on a weather condition.

29. The method of claim 27, wherein said at least one delivery date is determined based on a weather condition.

30. A method for determining shipping information comprising:
in response to receiving a request for shipping information from a user device at a system, executing instructions on said system such that said system implements:
determining at least one shipping option based on said request for shipping information received from said user device;
determining at least one delivery date of a shipment responsive to said request for shipping information received from said user device; and
transforming said at least one shipping option and said at least one delivery date into a format for said user device.

31. The method of claim 30 further comprising determining a weather condition responsive to said request.

32. The method of claim 30, wherein said request is generated in response to a user selection on said user device.

33. The system of claim 31, wherein determining said weather condition is based on said at least one delivery date of said shipment.

34. The method of claim 30, wherein determining said at least one delivery date is based on said at least one shipping option.

35. The method of claim 30 further comprising determining at least one rule responsive to said request.

36. The method of claim 35, wherein determining said at least one delivery date is based on said at least one rule.

37. The system of claim 35, wherein determining said at least one shipping option is also based on said at least one rule.
